(19) United States
(12) Patent Application Publication
(10) Pub. No.: US 2006/0163299 A1
(43) Pub. Date: Jul. 27, 2006

(54) Article carrier and spare tire carrier for an all-terrain vehicle

(76) Inventor: John Corlett, New Brunswick (CA)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/314,250

(22) Filed: Dec. 21, 2005

(30) Foreign Application Priority Data
Dec. 23, 2004 (CA) 2,490,913

(51) Int. Cl. B60R 7/00; B60R 9/00

(52) U.S. Cl. 224/401; 224/42.13; 224/42.39

(57) ABSTRACT

An article carrier for an All Terrain Vehicle includes an upper and lower support frame for attaching the article carrier to the rear of the vehicle. To one side of the support frame a wheel mount is located for the attachment of a spare tire. Attached to the opposite side of the support frame is an article tray which can receive items such as a gas can or tool box and are provided with a releasable hold-down member to firmly secure the items to the article tray. Located on the outermost section of the wheel mount, centrally mounted in respect to the spare tire, is a surface for mounting items such as a sticker.

This invention is in the field All Terrain Vehicle article carriers, and more particularly pertains to article carriers designed for rear attachment to the All Terrain Vehicle for the purpose of carrying a spare tire and other articles such as a gas can or tool box.

### BACKGROUND

Due to the All Terrain Vehicles' ability to travel into remote areas, a need has developed for an article carrier that allows the operator to carry a spare tire and extra gas or equipment with him or her as they travel to these areas. Most punctures and slow leaks can be repaired on the trail with simple devices such as plugs and spraying devices most commonly referred to as “slime.” However, slashed tires (holes too large to be repaired with the previously mentioned devices) or bent rims, which are caused by hard structures, such as rocks, striking the rim and bending the rim enough to not allow a proper seal, these repairs require the replacement of the tire and rim.

Article carriers (racks), ATV Support Rack Apparatus, Article Carrier Apparatus for Vehicles, and Outboard Motor and Gas Tank Carrier are specifically designed for vehicles, personal recreational vehicles, and All Terrain Vehicles are shown, for example, in the following Canadian and United States of America patents: Canadian Patent No. 2,427,706; Canadian Patent No. 2,267,705; U.S. Pat. No. 5,236,062; and U.S. Pat. No. 3,658,201.

Though such article carriers are designed to carry articles on vehicles, personal recreational vehicles, and All Terrain Vehicles, none adequately allow for the attachment of a spare tire and article carrier at the rear of an All Terrain Vehicle freeing up the traditional storage areas on the All Terrain Vehicle.

### SUMMARY OF THE INVENTION

It is an object of the present invention to provide a system and method for providing extra carrying capacity on an All Terrain Vehicle that overcomes problems in the prior art.

In view of the foregoing disadvantages inherent in the known types of All Terrain Vehicle article carriers (racks) now present in the prior art, the present invention provides an All Terrain Vehicle article carrier that attaches to the rear of an All Terrain Vehicle freeing up the traditional storage space on an All Terrain Vehicle.

To attain this, the present invention provides an upper and lower support frame for the mounting of the spare tire and article tray to the All Terrain Vehicles rear framework. The wheel mount is attached to the upper and lower support frame at one end. The spare tire is attached to the wheel mount with wheel fasteners. The article tray is attached to the upper and lower support frame at the opposite end in respect to the wheel mount. Articles are secured in the article carrier and supported by a releasable hold down membrane. The releasable hold down membrane is attached to both the upper support frame and the article tray and is placed over the articles as to secure the items to the article tray.

It is also an object of this invention to provide an article carrier for an All Terrain Vehicle which is susceptible of low cost of manufacture with regard to both materials and labor, and which accordingly is then susceptible of low prices of sale to the consuming public, thereby making such All Terrain Vehicle article carrier economically available to the buying public.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a rear view of a first embodiment of an article carrier of the present invention attached to the back of an All Terrain Vehicle and carrying a gas can and a spare tire;

FIG. 2 is a perspective illustration of the article carrier attached to the rear frame of an All Terrain Vehicle without the articles; spare tire and gas can, as shown in FIG. 1;

FIG. 3 is a side view of the wheel mount of the article carrier, shown without a spare tire mounted on it, attached to the upper and lower support frames which is attached to the rear frame of an All Terrain Vehicle; and

FIG. 4 is a side view of the article tray of the article carrier, shown with a gas can, attached to the upper and lower support frames which is attached to the rear frame of an All Terrain Vehicle.

### DETAILED DESCRIPTION OF THE ILLUSTRATED EMBODIMENTS

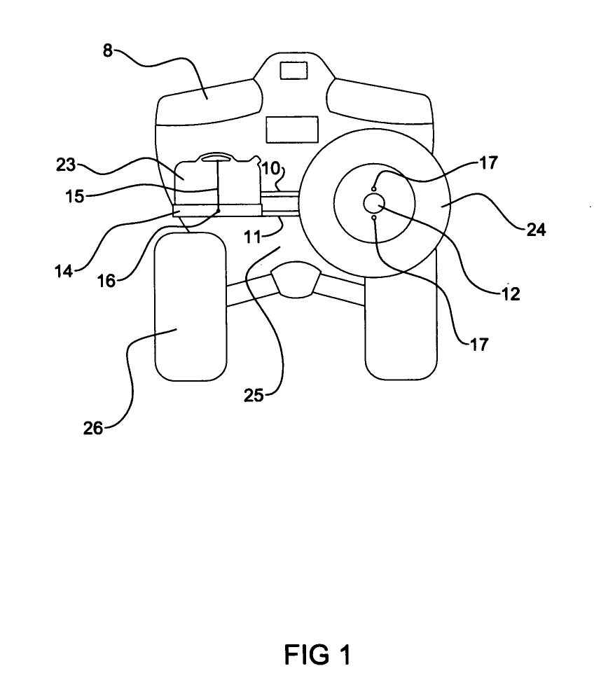

Referring now in detail to the drawings, FIG. 1 illustrates an article carrier 25 embodying features of the present invention mounted at the rear of a conventional All Terrain Vehicle 26 and is shown carrying a gas can 23 and spare tire 24 for the All Terrain Vehicle 26.

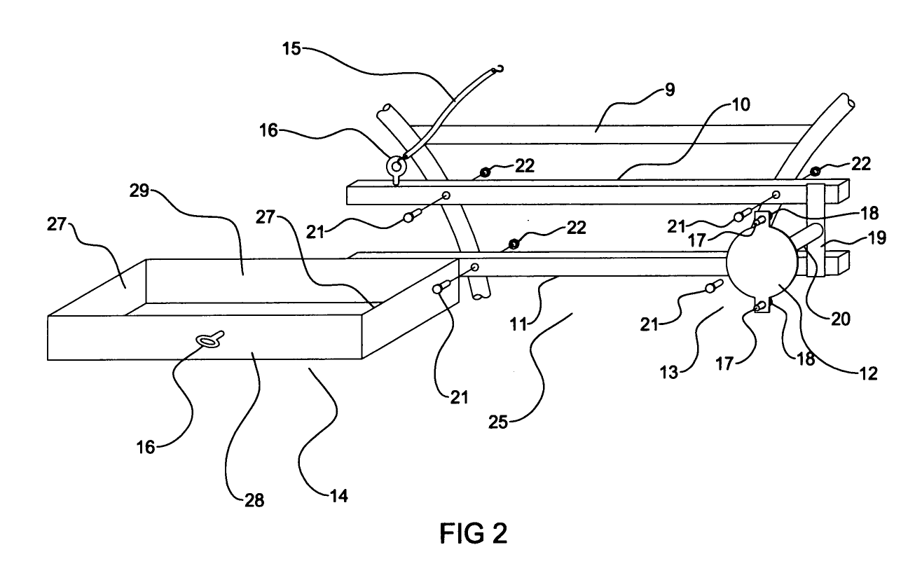

FIG. 2 illustrates the embodiment of the article carrier as illustrated in FIG. 1. The article carrier 25 shown broadly comprises an upper support frame 10 and a lower support frame 11, a wheel mount 13, and an article tray 14.

The upper support frame 10 and lower support frame 11 generally run horizontally and parallel in respect to one another and attach to the rear of the All Terrain Vehicle 26 at the rear mounting surface 9. Attachment of the upper support frame 10 and the lower support frame 11, to the rear mounting surface 9, is achieved by fasteners 21 and bolts 22.

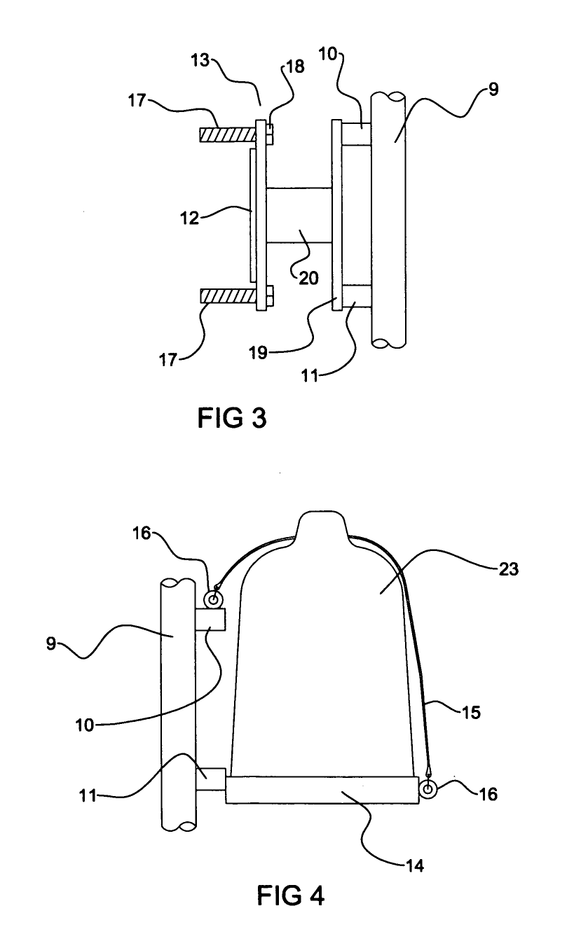

FIG. 3 illustrates a side view of the wheel mount 13 portion of the article carrier 25. The wheel mount 13 comprises an inner plate 19, an outer plate 18, a support arm 20, wheel fasteners 17, and a mounting surface 12. The wheel mount 13 is secured to the upper support frame 10 and the lower support frame 11 by the attachment of the inner plate 19 to the upper support frame 10 and the lower support frame 11. The outer plate 18 is connected to the inner plate 19 by the support arm 20. The outer plate 18 is further provided with wheel fasteners 17 suitably arranged thereon to align with the apertures in the vehicle wheel so that a spare tire (not shown) may be firmly attached on the wheel mount 13. The wheel mount 13 is further provided with a mounting surface 12 centrally located in respect to the spare tire 24 for the purpose of mounting items such as stickers.

Referring again to FIG. 2, the article tray 14, for transporting items such as a gas can (not shown), is comprised of end supports 27, outer support 28, inner support 29, and the releasable hold down member connector 16. The article tray 14 is secured to the lower support frame 11 by welding or other suitable methods. Referring to FIG. 4, articles such as a gas can 23, are secured to the article tray 14 by the attachment of a releasable hold down membrane 15 which is attached to the upper support frame 10 by means of a releasable hold down membrane connector 16 which is attached to the upper support frame 10. The releasable hold down membrane 15 is placed over or through an article such as a gas can 23 and attached to the front of the article tray 14 by means of a releasable hold down member connector 16 which is attached to the outer support 28.

From the foregoing it is apparent that the spare tire and article carrier is readily fastened to the rear portion of an All Terrain Vehicle utilizing the existing structure and it may be made of tubular, right-angle, flat bar, or other suitable material, welded or fastened together as an integral articulated unit. While particular vehicle attachment members have been described which lend themselves to a quick attachment operation, it is understood that other forms of attachment members and fasteners could be employed.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

I claim:

1. An article carrier for the attachment to the rear of an All Terrain Vehicle for the transport of a spare tire and articles such as a gas can or tool box.

2. The article carrier according to claim 1 wherein the article carrier is adapted to be releasably attached to the rear of an All Terrain Vehicle by means of fasteners which pass through an upper support frame and a lower support frame and attaching the article carrier to a rear mounting surface on the All Terrain Vehicles.

3. An article carrier according to claim 2 comprising a wheel mount attached to the upper support frame and the lower support frame.

4. An article carrier according to claim 3 wherein said wheel mount comprises: an inner plate attached to the upper support frame and lower support frame; a support arm attached to the inner plate operative to provide a space between a spare tire mounted on the wheel mount and a rear mounting surface of the All Terrain Vehicle; and an outer plate attached to the support arm and comprising fasteners for the attachment of a spare tire to the outer plate.

5. An article carrier according to claim 1 comprising: an article tray attached to the lower support frame; and releasable hold down member connectors, wherein the article tray has a recessed area for the storage of articles and the releasable hold down member connectors are operative to secure a releasable hold down member put over or through articles placed in the article tray.

6. An article carrier according to claim 4 further comprising a mounting surface on the outer plate of the wheel mount, the mounting surface is centrally located in respect to the outer perimeter of a spare tire mounted on the wheel mount and rearward facing wherein the mounting surface is operative to allow the placement of stickers.
